(19) United States
(12) Patent Application Publication
(10) Pub. No.: US 2025/0315402 A1
(43) Pub. Date: Oct. 9, 2025

(54) METHOD AND APPARATUS FOR TRAINING SPI CONTROLLER FOR HIGH-FREQUENCY OPERATION

(71) Applicant: Microchip Technology Incorporated, Chandler, AZ (US)

(72) Inventors: Robin Jonah Solomon, Chennai (IN); Art Speziale, Hauppauge, NY (US); Dan Thornton, Holbrook, NY (US)

(73) Assignee: Microchip Technology Incorporated, Chandler, AZ (US)

(21) Appl. No.: 19/169,556

(22) Filed: Apr. 3, 2025

(30) Foreign Application Priority Data
Apr. 3, 2024 (IN) 202441027512

(51) Int. Cl. G06F 13/42; G06F 9/4401

(52) U.S. Cl. CPC G06F 13/4291; G06F 9/4415

(57) ABSTRACT

A method for training a serial peripheral interface (SPI) controller is provided. The method may include receiving a first data set at a first clock frequency based on a plurality of delayed clock signals corresponding to a plurality of TAP values, obtaining a second data set at a second clock frequency based on the plurality of delayed clock signals corresponding to the plurality of TAP values, determining a plurality of pass/fail statuses for the respective plurality of TAP values by comparing the second data set obtained at the second clock frequency with the first data set received at the first clock frequency, setting the plurality of pass/fail statuses based on the comparison, and selecting, based on the plurality of pass/fail statuses, a selected TAP value from the plurality of TAP values corresponding to one of the plurality of delayed clock signals.

### CROSS-REFERENCE TO RELATED APPLICATION

The present application claims priority to Indian Provisional Patent Application No. 202441027512 filed on Apr. 3, 2024, which is incorporated herein by reference in its entirety.

### TECHNICAL FIELD

The present disclosure relates generally to serial peripheral interfaces, and more specifically to a method and an apparatus for training a serial peripheral interface (SPI) controller for high-frequency operation.

### BACKGROUND

Serial Peripheral Interface (SPI) flash memory is a widely used technology for embedded systems due to its simplicity, low power consumption, and suitability for short-distance communication. However, as the demand for faster server boot times and higher data transfer rates increases, some SPI controllers encounter limitations when operating at higher frequencies. During SPI communication, data (RX data) from the SPI flash memory is driven on the falling edge of the clock signal (SCK) and captured by the controller at the rising edge. At high frequencies, the time required for the data to become stable before it is captured affects the ability to accurately capture the data. Some controllers may fall short to address this setup time issue, leading to data capture errors. It is possible to delay the clock signal SCK to enable the data to be received correctly by using multiple delay cells of fixed duration. The output of each delay cell is called a TAP point, and the delayed clock signal output from one or more TAP points may be used to sample incoming data. Currently, the TAP value is chosen during the validation stage and programmed into the controller. However, manufacturing variations (process), power supply fluctuations (voltage) and changes in operating temperature may significantly alter the propagation delays of the clock signal. Over time, the pre-programmed TAP value may become insufficient to avoid data capture errors. Some controllers lack the ability to dynamically adjust the TAP value based on real-time ambient conditions. Therefore, there is a need for a method and an apparatus that addresses the limitations of some SPI controllers operating at higher frequencies and in challenging environments.

### SUMMARY

According to an aspect of one or more examples, there is provided a method to train a serial peripheral interface (SPI) controller for high-frequency operation. The method may include receiving a first data set at a first clock frequency, obtaining a second data set at a second clock frequency and training the SPI controller for a predetermined number of iterations. The training operation may include identifying a pass/fail status for each of a plurality of TAP values. The identifying operation may include comparing the second data set obtained at the second clock frequency with the first data set received at the first clock frequency and setting the pass/fail status based on the comparison.

The first data set may be received from a boot address of an external SPI flash memory. The method may include storing the first data set in a non-volatile memory of the SPI controller. The second data set may be obtained from the external SPI flash memory. The training operation may include calculating an average TAP value of the plurality of TAP values for each of the predetermined number of iterations. The calculating operation may include identifying a lowest indexed TAP value and a highest indexed TAP value where the comparison results in a pass status and calculating the average TAP value of the lowest indexed TAP value and the highest indexed TAP value. The training operation may include determining a selected TAP value based on a highest occurrence count of an average TAP value within a plurality of average TAP values. The method may include storing the selected TAP value in a TAP control register. The method may include storing a plurality of pass/fail statuses for each of the plurality of TAP values in a static random-access memory (SRAM). The method may include repeating the receiving operation, the obtaining operation and the training operation for one or more other chip selects of the SPI controller.

According to an aspect of one or more examples, there is provided a serial peripheral interface (SPI) controller which may include a plurality of shift registers, a comparator operatively coupled to the plurality of shift registers and a training control circuitry. The training control circuitry may receive a first data set at a first clock frequency, obtain a second data set at a second clock frequency and train the SPI controller for a predetermined number of iterations by identifying a pass/fail status for each of a plurality of TAP values. The identifying operation may include comparing the second data set obtained at the second clock frequency with the first data set received at the first clock frequency and setting the pass/fail status based on the comparison.

The training control circuitry may receive the first data set from a boot address of an external SPI flash memory. The first data set may be stored in a non-volatile memory of the SPI controller. The training control circuitry may obtain the second data set from the external SPI flash memory. The training control circuitry may calculate an average TAP value of the plurality of TAP values for each of the predetermined number of iterations by identifying a lowest indexed TAP value and a highest indexed TAP value where the comparison results in a pass status and calculating the average TAP value of the lowest indexed TAP value and the highest indexed TAP value. The training control circuitry may determine a selected TAP value based on a highest occurrence count of an average TAP value within a plurality of average TAP values. The SPI controller may include a TAP control register to store the selected TAP value determined by the training control circuitry. The SPI controller may include a static random-access memory (SRAM) to store a plurality of pass/fail statuses for each of the plurality of TAP values. The training control circuitry may repeat the repeat the receiving operation, the obtaining operation and the training operation for one or more other chip selects of the SPI controller.

According to an aspect of one or more examples, there is provided a computer-readable storage medium storing instructions that, when executed by a processor, cause the processor to perform a method to train a serial peripheral interface (SPI) controller for high-frequency operation.

### BRIEF DESCRIPTION OF DRAWINGS

FIG. 1 shows a block diagram illustrating a serial peripheral interface (SPI) controller according to one or more examples.

FIG. 2 shows a flowchart illustrating a method for training a serial peripheral interface (SPI) controller for high-frequency operation according to one or more examples.

FIGS. 3A & 3B show a flowchart illustrating blocks for training a serial peripheral interface (SPI) controller according to one or more examples.

FIG. 4 shows a block diagram illustrating a TAP selection system for a serial peripheral interface (SPI) controller according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

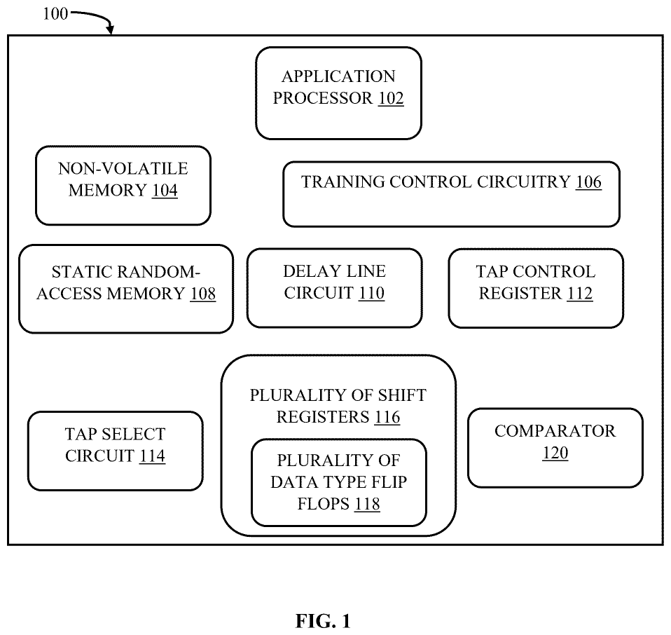

FIG. 1 shows a block diagram illustrating a serial peripheral interface (SPI) controller 100 according to one or more examples. The SPI controller 100 may include an application processor 102, a non-volatile memory 104, a static random-access memory (SRAM) 108, a training control circuitry 106, a delay line circuit 110, a tap control register 112, a tap select circuit 114, a plurality of shift registers 116, and a comparator 120. The plurality of shift registers 116 may include a plurality of data type flip flops 118.

The application processor 102 may serve as a central processing unit of the SPI controller 100, to orchestrate various aspects of a training operation. The application processor 102 may access addresses and perform various operations within the SPI controller 100 to control the training operation. The application processor 102 may initiate the training of the SPI controller 100 by triggering the training control circuitry 106. The application processor 102 may access an SPI flash address, which corresponds to a specific location within an external SPI flash memory identified during the training operation associated with a chip select of the SPI controller 100. Specifically, the application processor 102 may interact with the training control circuitry 106, read data from the external SPI flash memory, and communicate with other components.

The non-volatile memory 104 may store the SPI flash address, a mode information and a firmware. In one or more examples, the non-volatile memory 104 may be a one-time programmable (OTP) memory and a flash memory. The application processor 102 may access the SPI flash address stored in the non-volatile memory 104 to initiate the training operation for the corresponding chip select. The mode information may indicate a communication mode for the external SPI flash memory. In one or more example, the communication mode may be a single communication mode, a dual communication mode, and a quad communication mode.

The firmware may be a set of instructions stored in the non-volatile memory 104. The firmware may act as an intermediary between the hardware (e.g., the application processor 102) and software (e.g., application programs). The firmware may provide specific instructions to the application processor 102 to execute for various tasks related to the training of the SPI controller 100. The application processor 102 may fetch and interpret firmware instructions from the non-volatile memory 104 during the training of the SPI controller 100. The firmware instructions may guide the application processor 102 to access and interpret the SPI flash address. The firmware may instruct the application processor 102 to access a specific SPI flash address stored in the non-volatile memory 104 and recognize the SPI flash address as a trigger to initiate the training of the SPI controller 100.

The firmware may provide instructions for the application processor 102 to interact with other components of the SPI controller 100 like the comparator 120, the delay line circuit 110, and the training control circuitry 106. These instructions may include sending signals, retrieving data, and performing calculations. The firmware may dictate the operations involved in the training operation, such as adjusting the delay line circuit 110, reading data from the external SPI flash memory, storing pass/fail statuses, and identifying a selected TAP value. The application processor 102, equipped with its processing power, may execute aforementioned instructions to ensure the smooth and efficient training of the SPI controller 100.

The training control circuitry 106 may control the training operation, managing the adjustment of the delay line circuit 110 for the SPI controller 100 and data analysis. The training control circuitry 106 may receive a first data set at a first clock frequency. The first data set may act as a reference for comparison during the training operation. The first data set may be received from a boot address of the external SPI flash memory. The first data set may be stored in the non-volatile memory 104 of the SPI controller 100. The training control circuitry 106 may obtain a second data set at a second clock frequency from the external SPI flash memory. The second data set may correspond to an actual data received by the chip select of the SPI controller 100 during the training operation at a higher frequency. The second clock frequency may be higher than the first clock frequency.

The training control circuitry 106 may run for a predetermined number of iterations to train the SPI controller 100. The training control circuitry 106 may be operatively coupled with the delay line circuit 110 to adjust a TAP value for each iteration. The training control circuitry 106 may be operatively coupled with the comparator 120 to compare the second data set obtained at the second clock frequency with the first data set received at the first clock frequency to identify a pass/fail status for each of a plurality of TAP values. The training control circuitry 106 may set the pass/fail status based on the comparison of the second data set with the first data set for each of the plurality of TAP values.

The training control circuitry 106 may identify a lowest indexed TAP value and a highest indexed TAP value where the comparison results in a pass status. The training control circuitry 106 may calculate an average TAP value of the lowest indexed TAP value and the highest indexed TAP value, which may correspond to the average TAP value of the plurality of TAP values for each of the predetermined number of iterations. The training control circuitry 106 may determine the selected TAP value based on a highest occurrence count of the average TAP value within a plurality of average TAP values, which is used for tuning the delay line circuit 110. The selected TAP value may correspond to an average TAP value appearing most frequently across the predetermined number of iterations. The selected TAP value may be stored in the TAP control register 112.

The SPI controller 100 may include the SRAM 108 to store a plurality of pass/fail statuses derived from the comparison of the first data set and the second data set for each of the predetermined number of iterations, enabling iterative refinement of clock delay settings of the delay line circuit 110. The training control circuitry 106 may repeat the receiving operation, the obtaining operation and the training operation for one or more other chip selects of the SPI controller 100. The SPI controller 100 may include a reset TAP register (not shown) operable to reset the TAP value.

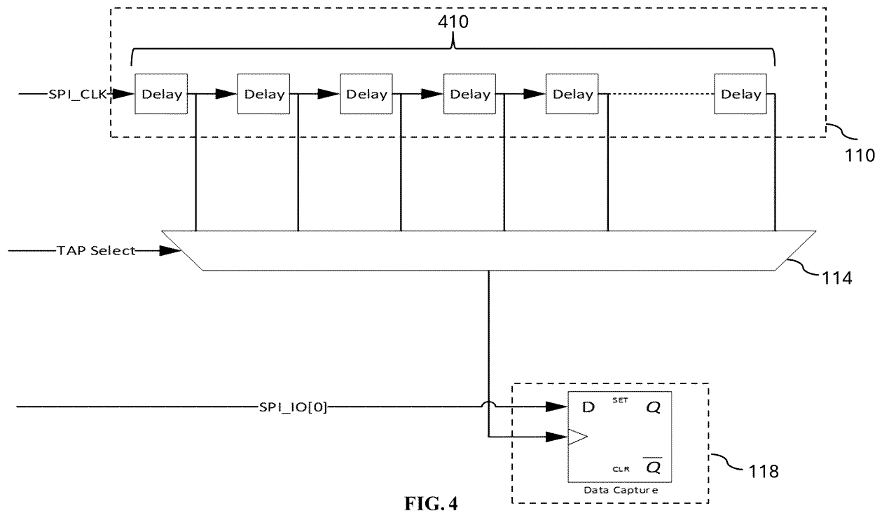

The delay line circuit 110 may include a plurality of delay elements (shown in FIG. 4), each having an input and an output. The delay line circuit 110 may control a serial peripheral interface clock signal through the plurality of delay elements. It may allow the SPI controller 100 to explore the plurality of TAP values during the training operation. The delay line circuit 110 is operatively coupled with the TAP select circuit 114. The TAP select circuit 114 may select the selected TAP value stored in the TAP control register 112 identified during the training operation. The TAP select circuit 114 may receive the selected TAP value with the highest number count for data capture. The TAP select circuit 114 may use the selected TAP value to control the plurality of delay elements of the delay line circuit 110.

The TAP select circuit 114 may effectively control delay introduced by the plurality of delay elements of the delay line circuit 110 based on the selected TAP value. The TAP select circuit 114 may be operatively coupled to the plurality of shift registers 116. The plurality of shift registers 116 may respectively include a plurality of data type flip flops 118. A data stream from the external SPI flash memory may be fed into the plurality of data type flip flops 118 of the respective plurality of shift registers 116. The selected TAP value may be communicated through the TAP select circuit 114 to the plurality of data type flip flops 118 to control a timing at which the data stream from the external SPI flash memory is fed within the plurality of shift registers 116.

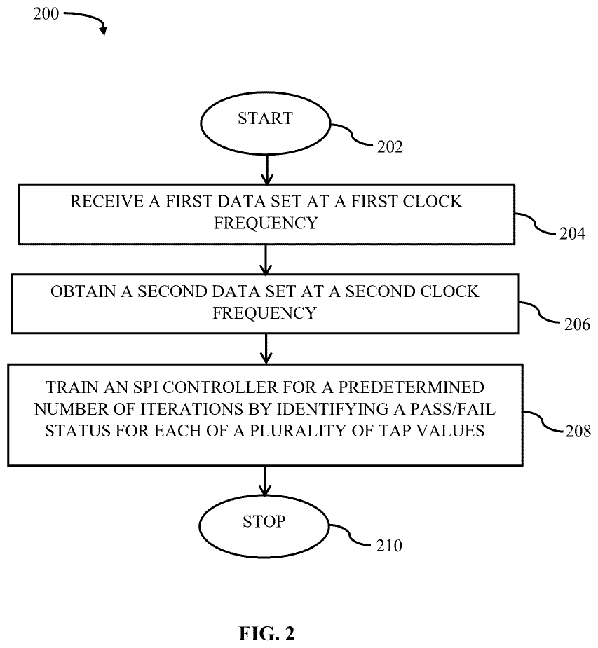

FIG. 2 shows a flowchart 200 illustrating a method for training the serial peripheral interface (SPI) controller 100 for high-frequency operation according to one or more examples. It may be noted that in order to explain the method of the flowchart 200, references will be made to the elements explained in FIG. 1.

The flowchart 200 starts at operation 202. At operation 204, the method may include receiving the first data set at the first clock frequency. At operation 206, the method may include obtaining the second data set at a second clock frequency. At operation 208, the method may include training the SPI controller 100 for the predetermined number of iterations by identifying the pass/fail status for each of the plurality of TAP values.

The flowchart 200 terminates at operation 210. It may be noted that the flowchart 200 is explained to have above stated process operations; however, those skilled in the art would appreciate that the flowchart 200 may have more/less number of process operations which may enable all the above stated examples of the present disclosure.

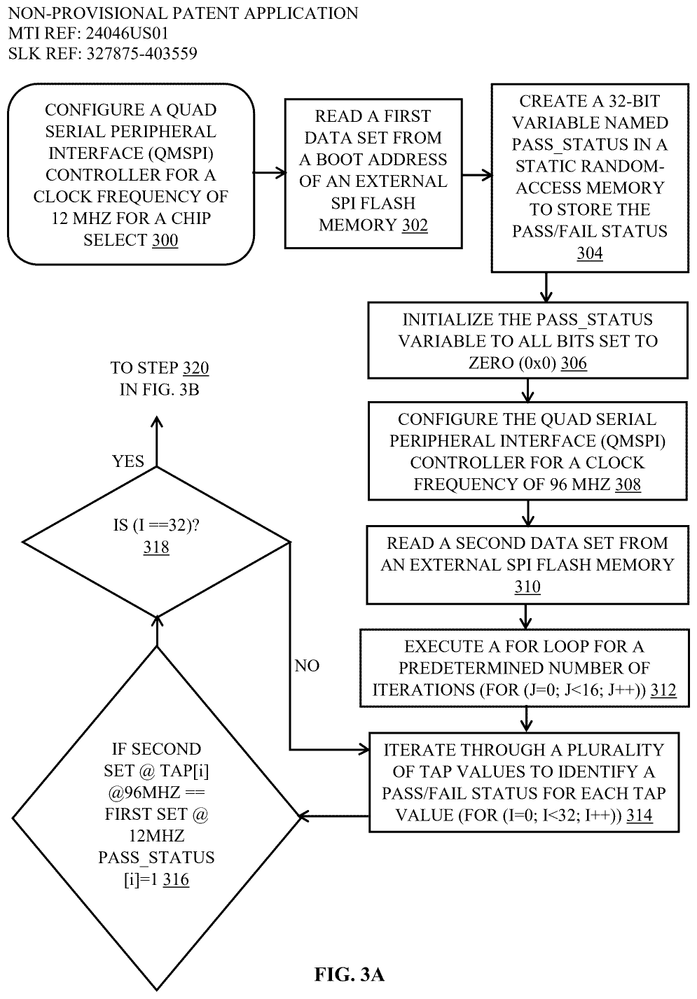

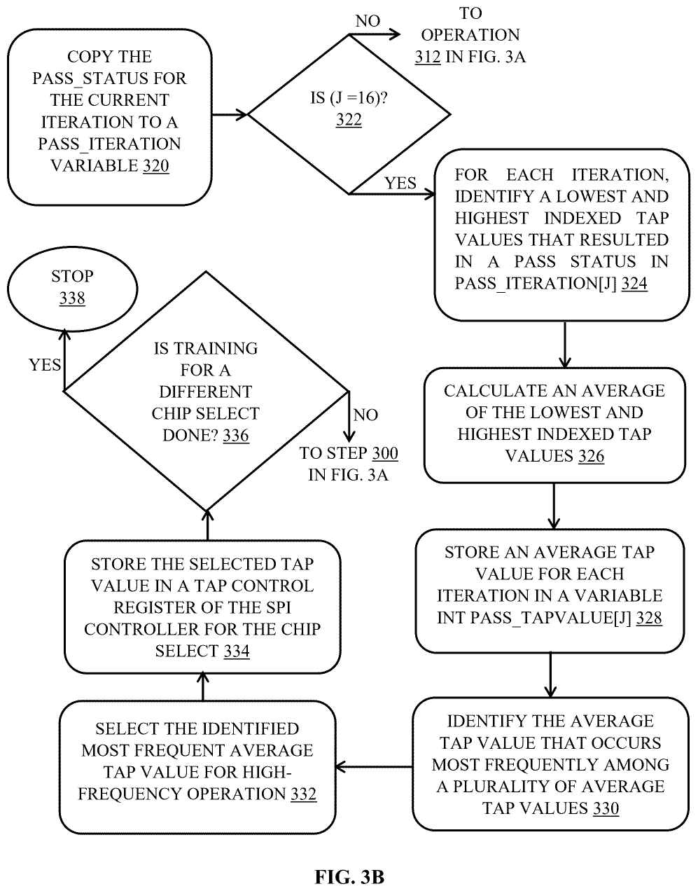

FIG. 3A and FIG. 3B in combination, illustrate a flow diagram for training the SPI controller 100 according to various examples. At operation 300, the application firmware may configure the SPI controller 100, which may be a quad mode serial peripheral interface controller, to operate at about 12 MHz clock frequency for a chip select (e.g., CS0 #). At operation 302, the application firmware may initiate a read operation to receive the first data set from the boot address of the external SPI flash memory using the 12 MHz clock frequency. The first data set may be stored within the non-volatile memory 104 using an existing byte hash. At operation 304, variable, for example a 32-bit variable named pass_status, may be created in the static random-access memory 108 to store the pass/fail status.

At operation 306, the pass_status variable may be initialized so all bits are set to a logic value of zero (bit Pass_Status [31:0]=0x0). At operation 308, the application firmware may configure the quad mode serial peripheral interface controller to operate at about 96 MHz clock frequency for the chip select. At operation 310, the application firmware may initiate a read operation to obtain the second data set from the external SPI flash memory using the clock frequency of about 96 MHz. At operation 312, a FOR loop may be executed for the predetermined number of iterations (e.g., for (j=0; j<16; j++)). In one or more examples, the predetermined number of iterations may be about 16. At operation 314, the method may iterate through the plurality of TAP values, which may be about 32, to identify the pass/fail status for each TAP value (e.g., for (i=0; i<32; i++)). For example, at operation 316, it is determined whether or not the second data set obtained at about 96 MHz clock frequency using the current TAP value matches the first data set received earlier at about 12 MHz clock frequency. The pass_status variable for the current TAP value may be set to a logic value of 1 if there is a match between the first data set and the second data set.

At operation 318, it is determined whether or not the current TAP value “i” is equal to the last TAP value, which according to various examples may be 32. If it is determined that the current TAP value is not equal to 32 in operation 318, the method may proceed back to operation 314, where the current TAP value is incremented. The method proceeds again to operation 316, where it is determined whether or not the second data set obtained at about 96 MHz clock frequency using the current TAP value (which has been incremented since the previous TAP value was used) matches the first data set received earlier at about 12 MHz clock frequency. The pass_status variable for the current TAP value may be set to a logic value of 1 if there is a match between the first data set and the second data set. At step 318, it is again determined whether the current TAP value ‘i’ is equal to the last TAP value. If the current TAP value ‘i’ is not equal to the last TAP value, the method returns to operation 314, where the current TAP value is again incremented, and operations 316 and 318 are repeated so that a pass_status variable value is determined for each TAP value. When the current TAP value ‘i’ is determined to match the last TAP value in operation 318, the method proceeds to operation 320.

At operation 320, the pass_status variable for a current iteration “j” may be copied to a pass_iteration variable (pass_iteration [j]=pass_status). In operation 322, it is determined whether or not the current iteration “j” is equal to the predetermined number of iterations, e.g., 16. If it is determined that the current iteration for the chip select is not equal to the predetermined number of iterations in operation 322, the method may proceed to operation 312, where the current iteration number is incremented, and operations 314, 316, and 318 are repeated for each of the TAP values ‘i’ and a pass_status value is determined for each TAP value ‘i’. When operations 314, 316, and 318 have been performed for each TAP value ‘i’ of the current iteration ‘j’, the pass_status variable for the current iteration “j” may be copied to a pass_iteration variable (pass_iteration [j]=pass_status) in operation 320. In operation 322, it is again determined whether or not the current iteration “j” is equal to the predetermined number of iterations, and if not, the method returns to operation 312 where the current iteration is incremented and operations 314, 316, and 318 are repeated for each TAP value. The method continues in this manner until it is determined that the current iteration ‘j’ for the chip select is equal to the predetermined number of iterations in operation 322, in which case the method may proceed to operation 324.

At operation 324, for each iteration ‘j’ the lowest indexed TAP value and the highest indexed TAP value that resulted in the pass_iteration variable set to a logic value of 1 may be identified. At operation 326, the average of the lowest indexed TAP value and the highest indexed TAP value may be calculated. At operation 328, the average TAP value for each iteration ‘j’ may be stored in an integer variable, which may be designated as “pass_tapvalue [j]”. At operation 330, the average TAP value that occurs most frequently among the plurality of average TAP values may be identified. At operation 332, the identified most frequent average TAP value may be selected for the high-frequency operation. At operation 334, the selected TAP value may be stored in the TAP control register 112 of the SPI controller 100 for the chip select. At operation 336, it is determined whether or not training for a different chip select (e.g., CS1 #) is done. If the training for the different chip select is done, at operation 336, the training operation is stopped at operation 338. If it is determined that the training for the different chip select is not done in operation 336, the method proceeds back to operation 300, and the method is repeated for the next chip select. By training the SPI controller 100 according to the examples described herein, the TAP value may be adjusted to account for external factors such as board parasitic and ambient conditions. The ability to adjust the TAP value based on such factors may enable the SPI controller to function more reliably at higher frequencies, and account for variations in process, voltage, and temperature.

FIG. 4 shows a block diagram illustrating a TAP selection system for the serial peripheral interface (SPI) controller 100 according to one or more examples. It may be noted that in order to explain the TAP selection system, references will be made to the elements explained in FIG. 1. The TAP selection system may include the delay line circuit 110, the TAP select circuit 114 and the plurality of data type flip flops 118.

The delay line circuit 110 may include the plurality of delay elements 410. The delay line circuit 110 may control the serial peripheral interface clock signal designated as “SPI CLK” through the plurality of delay elements. The plurality of delay elements 410 are operatively coupled with the TAP select circuit 114. The TAP select circuit 114 may select the selected TAP value stored in the TAP control register 112 identified during the training operation. The TAP select circuit 114 may receive the selected TAP value with the highest number count through a TAP Select signal form the TAP control register 112. The TAP select circuit 114 may use the selected TAP value to control the plurality of delay elements 410 of the delay line circuit 110.

The TAP select circuit 114 may effectively control delay introduced by the plurality of delay elements 410 of the delay line circuit 110 based on the selected TAP value. The TAP select circuit 114 may be operatively coupled to the plurality of data type flip flops 118. The data stream designated as “SPI_IO [0]” from the external SPI flash memory may be fed into the plurality of data type flip flops 118 of each of the plurality of shift registers 116. The selected TAP value may be used by the TAP select circuit 114 to output a delayed clock signal to the plurality of data type flip flops 118 to control the timing at which SPI_IO [0] signal from the external SPI flash memory is fed within the plurality of shift registers 116.

Various examples have been disclosed herein, in connection with the above description and the drawings. It will be understood that it would be unduly repetitious to literally describe and illustrate every combination and subcombination of these examples. Accordingly, all examples can be combined in any way and/or combination, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A method for training a serial peripheral interface (SPI) controller, the method comprising:
generating a plurality of delayed clock signals based on a received clock signal, wherein the plurality of delayed signals respectively correspond to a plurality of TAP values respectively indicating an amount of delay for the plurality of delayed clock signals;
receiving a first data set at a first clock frequency, wherein the first data set includes data received based on the plurality of delayed clock signals corresponding to the plurality of TAP values;
obtaining a second data set at a second clock frequency, wherein the second data set includes data received based on the plurality of delayed clock signals corresponding to the plurality of TAP values; and
training the SPI controller for a predetermined number of iterations, wherein the training operation comprises:
determining a plurality of pass/fail statuses for the respective plurality of TAP values by comparing the second data set obtained at the second clock frequency with the first data set received at the first clock frequency;
setting the plurality of pass/fail statuses based on the comparison; and
selecting, based on the plurality of pass/fail statuses, a selected TAP value from the plurality of TAP values corresponding to one of the plurality of delayed clock signals.

2. The method of claim 1, wherein the first data set is received from a boot address of an external SPI flash memory.

3. The method of claim 1, further comprising storing the first data set in a non-volatile memory of the serial peripheral interface (SPI) controller.

4. The method of claim 1, the second data set is obtained from an external SPI flash memory.

5. The method of claim 1, wherein the training operation comprises, for each of the predetermined number of iterations:
identifying a plurality of lowest indexed TAP values and a plurality of highest indexed TAP values where the comparison results in a pass status, wherein the plurality of lowest indexed TAP values and plurality of highest indexed TAP values respectively correspond to the predetermined number of iterations; and
calculating a plurality of average TAP values of the plurality of lowest indexed TAP value and plurality of highest indexed TAP values respectively corresponding to the predetermined number of iterations.

6. The method of claim 5, wherein the training operation comprises determining the selected TAP value based on a highest occurrence count of an average TAP value within the plurality of average TAP values.

7. The method of claim 6, further comprising storing the selected TAP value in a TAP control register.

8. The method of claim 1, further comprising storing the plurality of pass/fail statuses for the plurality of TAP values in a static random-access memory (SRAM).

9. The method of claim 1, further comprising repeating the receiving operation, the obtaining operation and the training operation for one or more other chip selects of the SPI controller.

10. A serial peripheral interface (SPI) controller, comprising:
a plurality of shift registers;
a comparator operatively coupled to the plurality of shift registers;
a delay line circuit to generate a plurality of delayed clock signals based on a received clock signal, wherein the plurality of delayed signals respectively correspond to a plurality of TAP values respectively indicating an amount of delay for the plurality of delayed clock signals; and
a training control circuitry to:
receive a first data set at a first clock frequency, wherein the first data set includes data received based on the plurality of delayed clock signals corresponding to the plurality of TAP values;
obtain a second data set at a second clock frequency, wherein the second data set includes data received based on the plurality of delayed clock signals corresponding to the plurality of TAP values; and
train the SPI controller for a predetermined number of iterations:
determining a plurality of pass/fail statuses for the respective plurality of TAP values by comparing the second data set obtained at the second clock frequency with the first data set received at the first clock frequency;
setting the plurality of pass/fail statuses based on the comparison; and
selecting, based on the plurality of pass/fail statuses, a selected TAP value from the plurality of TAP values corresponding to one of the plurality of delayed clock signals.

11. The SPI controller of claim 10, wherein the training control circuitry is to receive the first data set from a boot address of an external SPI flash memory.

12. The SPI controller of claim 10, wherein the first data set is stored in a non-volatile memory of the SPI controller.

13. The SPI controller of claim 10, wherein the training control circuitry is to obtain the second data set from an external SPI flash memory.

14. The SPI controller of claim 10, wherein, for each of the predetermined number of iterations, the training control circuitry is to:
identify a plurality of lowest indexed TAP values and a plurality of highest indexed TAP values where the comparison results in a pass status, wherein the plurality of lowest indexed TAP values and plurality of highest indexed TAP values respectively correspond to the predetermined number of iterations; and
calculate a plurality of average TAP values of the plurality of lowest indexed TAP value and plurality of highest indexed TAP values respectively corresponding to the predetermined number of iterations.

15. The SPI controller of claim 14, wherein the training control circuitry is to determine the selected TAP value based on a highest occurrence count of an average TAP value within the plurality of average TAP values.

16. The SPI controller of claim 15, comprising a TAP control register to store the selected TAP value determined by the training control circuitry.

17. The SPI controller of claim 10, further comprising a static random-access memory (SRAM) to store the plurality of pass/fail statuses for the plurality of TAP values.

18. The SPI controller of claim 10, wherein the training control circuitry is to train the SPI controller for a predetermined number of iterations for multiple chip selects of the SPI controller.

19. A computer-readable storage medium storing instructions that, when executed by a processor, cause the processor to perform a method comprising:
generating a plurality of delayed clock signals based on a received clock signal, wherein the plurality of delayed signals respectively correspond to a plurality of TAP values respectively indicating an amount of delay for the plurality of delayed clock signals;
receiving a first data set at a first clock frequency, wherein the first data set includes data received based on the plurality of delayed clock signals corresponding to the plurality of TAP values;
obtaining a second data set at a second clock frequency, wherein the second data set includes data received based on the plurality of delayed clock signals corresponding to the plurality of TAP values; and
training the SPI controller for a predetermined number of iterations, wherein the training operation comprises:
determining a plurality of pass/fail statuses for the respective plurality of TAP values by comparing the second data set obtained at the second clock frequency with the first data set received at the first clock frequency;
setting the plurality of pass/fail statuses based on the comparison; and
selecting, based on the plurality of pass/fail statuses, a selected TAP value from the plurality of TAP values corresponding to one of the plurality of delayed clock signals.
